(19) United States
(12) Patent Application Publication
(10) Pub. No.: US 2021/0276667 A1
(43) Pub. Date: Sep. 9, 2021

(54) WATERWAY MARKER DEVICE AND RELATED ARRANGEMENT

(71) Applicant: FORNAVI OY, Kuopio (FI)

(72) Inventor: Junnu HAARA, Kuopio (FI)

(21) Appl. No.: 16/492,737

(22) PCT Filed: Feb. 23, 2018
(86) PCT No.: PCT/EP2018/054456

§ 371 Date: Sep. 10, 2019

(30) Foreign Application Priority Data
Mar. 10, 2017 (FI) 20175222

(51) Int. Cl. B63B 22/16

(52) U.S. Cl. CPC B63B 22/166

(57) ABSTRACT

A floating waterway marker device in the form of a buoy or a waterway navigation mark is provided. The device includes a body and an at least one light source, wherein in the body a number of periodically spaced recesses are circumferentially arranged to a predetermined depth. The waterway marker device further includes a number of optical fibers extending from the at least one light source to each of the recesses and configured to convey light emitted by the at least one light source such that exiting light is directed to an ambient around the periphery of the waterway marker device.

### FIELD OF THE INVENTION

Generally invention relates to devices for marking waterways and/or nautical navigation routes. In particular, the present invention concerns a floating marker device in the form of a buoy, in particular, a beacon buoy.

### BACKGROUND

Waterway marker devices are inevitable in safe navigation. While some types of floating markers have existed for centuries, the modern floating marker devices, such as buoys and navigational beacons, are provided in a wide variety of shapes, sizes, and color schemes.

In order to assure safe waterway navigation, provision of floating markers must include means that allow the mariner to identify and unmistakably ascertain the marker and indications thereon. In addition to variable sizes and appearances the floating markers, in particular, those, used in marine navigation, may be further equipped with communication means, such as radar transponders, GPS-, radio-, sound- and/or light signaling-/communication devices.

Historically, light identification has been accomplished by means of an at least one light source provided on a floating marker. Floating markers equipped with conventional lanterns normally require battery replacement at least every few years; however, continuous monitoring of an operational state thereof may still be indispensable. The problem is at least partially solved by utilizing solar powered marker buoys; however, such a solution is hardly adoptable in the Northern countries that may lack sunlight over the year round.

Another common approach for imparting visibility to floating markers is applying various (retro)reflective tapes, pads and paints thereon. However, as follows from the prefix “retro”, being indicative of a reflector's property to reflect light back towards its source; retroreflectors as means for identification are useful only in case there is light falling thereonto. Floating markers provided with retroreflectors as only identification means are not recognizable in the darkness, whether a vessel approaching thereto has signaling lights turned off

A further well-identified problem relates a fact that recognition of the lateral marks (green and red navigation marks indicative of the port (left) and starboard (right) sides of navigable waters or channels) is difficult for the mariners suffering from daltonism (color blindness), wherein green and red colors are simply not distinguished from each other. To deal with said problem, the conventional lateral marks include a geometric (typically, square- or triangular) motif on the top thereof to indicate left and right, accordingly. However, recognition of such marks during night time is practically impossible, if/when not lit by a lantern. Moreover, some navigation marks, such as used in lake navigation, for example, do not include the aforesaid indicative motifs at all.

In this regard, it would be desirable to update the field of technology related to waterway marker devices, such as buoys and beacon buoys, that exploit light-based signalling- and communication means, in view of providing a cost- effective solution for improving visibility and identifiability thereof in conditions of low battery (for a light source) and/or absence of ambient light.

### SUMMARY OF THE INVENTION

An objective of the present invention is to at least alleviate each of the problems arising from the limitations and disadvantages of the related art. The objective is achieved by various embodiments of a floating waterway marker device provided in one aspect of the invention, according to what is defined in the independent claim 1.

In preferred embodiment a floating waterway marker device comprising a body and an least one light source is provided, wherein in the body of said device a number of periodically spaced recesses are circumferentially arranged to a predetermined depth, wherein the waterway marker device further comprises a number of optical fibers coupled to said at least one light source and extending therefrom to each of the recesses, wherein each optical fiber is configured to convey incoming light emitted by the at least one light source such, that outgoing light is directed to an ambient around the periphery of the floating waterway marker device. The body of the floating waterway marker device is made of a material impermeable to light.

In some embodiments said floating waterway marker device is provided in the form of a buoy and/or a waterway navigation mark.

In some embodiments, in said floating waterway marker device each recess is further configured to receive a light transmissive layer thereinto, and each optical fiber is thus configured to convey incoming light emitted by said at least one light source to or through said light transmissive layer.

In some embodiment, in said floating waterway marker device the light transmissive layer comprises an optically functional surface formed by an array of optically functional elements configured, in terms of shape, orientation and disposition thereof on the light transmissive layer, to redirect incoming light rays to the ambient at a preselected angle alpha within a range of 45-120 degrees, preferably 90 degrees.

In some additional embodiment, in said floating waterway marker device the optically functional surface is provided on an additional optically functional layer disposed over or under the light transmissive layer.

In another embodiment, in said floating waterway marker device a clearance is formed between a base of the recess and the light transmissive layer upon receiving said light transmissive layer into the recess.

In some embodiment the at least one optical fiber is received into the clearance formed between the base of the recess and the light transmissive layer of said floating waterway marker device, via an at least one aperture. In some embodiment said at least one aperture is provided in the base of the recess.

In further embodiments, in said floating waterway marker device the light transmissive layer is a reflective layer.

In some embodiments, the floating waterway marker device comprises the light source configured as a light emitting diode or a laser diode.

In some embodiments, said at least one light source is an external light source provided at the top of the body of the floating waterway marker device. In some other embodiments said at least one light source is an internal light source being at least partly incorporated into the body of the floating waterway marker device.

In another aspect of the invention, an arrangement for marking a waterway navigation route is provided, according to what is defined in the independent claim 13, said arrangement comprises a number of the floating waterway marker devices according to the precious aspect.

The utility of the present invention arises from a variety of reasons depending on each particular embodiment thereof

At first, the floating waterway marker device provided hereby effectively combines the methods of light signaling with that by means of (retro)reflection. Thus, in addition to (retro)reflective appliance(s) said device effectively exploits principles of marine navigational aids based on light signaling, wherein light emissive function of said device is advantageously adjustable in terms of such parameters as light wavelength, frequency, cycle, amplitude, phase, time and intensity per time unit. The aforesaid parameters may be adjusted within each floating waterway marker device and within an arrangement comprising a number of said devices.

Moreover, versatile configuration of the floating waterway marker device of the present disclosure assures applicability thereof to practically any type of waterway navigation mark, including, but not limited to lateral marks, cardinal marks, danger marks, installation marks, safe water marks, emergency marks, special purpose marks, and the like.

Furthermore, the devices disclosed hereby are particularly useful to provide navigational aids to mariners suffering from daltonism.

The term “light transmissive” is utilized in the present disclosure in a meaning as generally capable of transmitting essentially all incoming light therethrough.

The term “reflective” is utilized in the present disclosure in a meaning of “light reflective”. The term “reflective” is further implied hereby with a meaning of “retroreflective”, unless otherwise explicitly indicated.

The term “light” is utilized in the present disclosure with regard to visible light, i.e. electromagnetic radiation in the range of wavelengths provided within a portion of the electromagnetic spectrum that is visible to the human eye. Such range normally constitutes 390 (blue)-700 nm (red).

The expression “a number of” refers herein to any positive integer starting from one (1), e.g. to one, two, or three. The expression “a plurality of” refers herein to any positive integer starting from two (2), e.g. to two, three, or four.

The term “element” may refer herein also to a multi-part element with multiple physically and/or functionally connected elements in addition to single-part or integrated elements.

Different embodiments of the present invention will become apparent by consideration of the detailed description and accompanying drawings.

### BRIEF DESCRIPTION OF THE DRAWINGS

FIGS. 1A and 1B show a perspective view of a floating waterway marker device 100, in accordance with some embodiments.

FIGS. 2A-DC schematically illustrate an arrangement of elements in a body 10 of the floating waterway marker device 100, in accordance with some embodiments.

FIGS. 3A-3C illustrate a process for assembling the arrangement of elements in the body 10 of the floating waterway marker device 100 in accordance with some embodiments.

### DETAILED DESCRIPTION OF THE EMBODIMENTS

Detailed embodiments of the present invention are disclosed herein with the reference to accompanying drawings. The same reference characters are used throughout the drawings to refer to same members. Following citations are used for the members:

100—a waterway marker device;

10—a body of the waterway marker device;

11, 11A—a recess and a base thereof, accordingly;

12—a light transmissive layer/a reflective layer;

12A—an optically functional surface;

13A, 13B—a light source;

14—an optical fiber;

15—a distribution box;

16—an aperture for the light guide 14;

17—a clearance formed between the recess and the reflective layer;

18—an additional optically functional layer;

21—incoming light;

22—outgoing light.

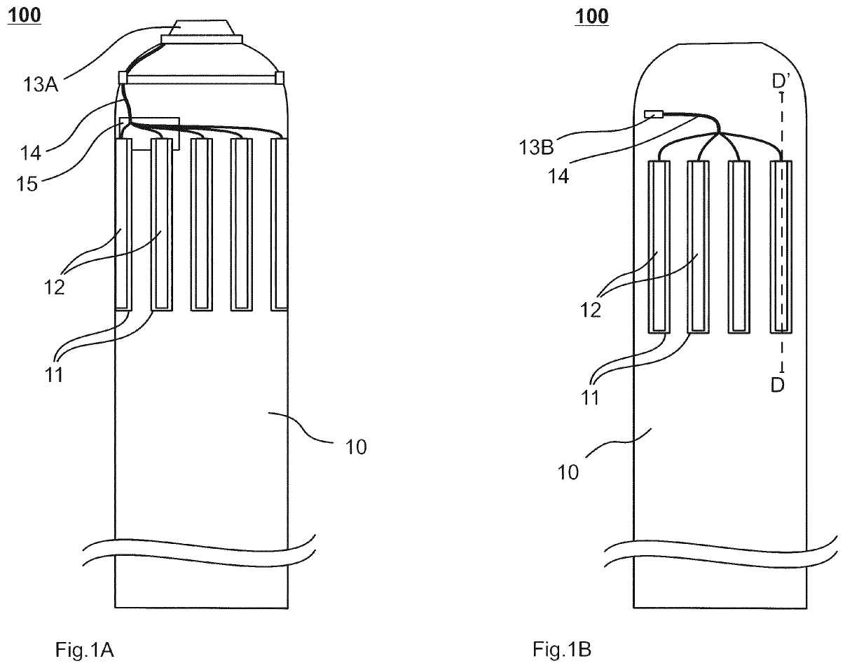

FIGS. 1A and 1B illustrate, at 100, a concept underlying various embodiments of a floating waterway marker device, in accordance with one aspect of the present invention. In preferred embodiment the floating waterway marker device 100 (hereby, “a device 100”) comprises a body 10, configured to float upright in the water, while anchored to the seabed, and an at least one light source 13A, 13B. FIGS. 1A and 1B show that part of the device 100 floating above the water; underwater part of the device 100 is not shown).

The device 100 is advantageously provided in the form of a buoy and/or a waterway navigation mark. Hereby, the aforesaid waterway navigation mark may be configured as a buoy, and vice versa. Moreover, versatile configuration of the device 100 assures applicability thereof to practically any type of waterway navigation mark, including, but not limited to lateral marks, cardinal marks, danger marks, installation marks, safe water marks, emergency marks, special purpose marks, and the like.

The device 100 comprises the body 10 preferably configured as an elongated, tube-like element. An outer diameter of the body 10 is in the range of 0.15-1 m, and an overall length thereof is in the range of 1-12 m, wherein a visual length (that of the over-the-water part) constitutes 0.5-5 m. Aforesaid dimensions vary depending on location and function of the floating waterway marker device. By the way of an example, a compact spar buoy for inland- and/or river navigation, as well as that for boat harbors and -channels has an outer diameter of 0.16-0.25 m, an overall length of 3.4 m, and a visual length of 2 m; whereas a massive spar buoy for open sea and/or arctic (ice-covered) areas has an outer diameter of 0.5 m, an overall length of 10-15 m, and a visual length of 3.5 m.

The device 100 may be further provided in alternative configurations and comprise a cone- or a barrel-shaped body 10, for example.

The body 10 of the device 100 is preferably manufactured of a polymeric material, in particular, of polyethylene or any other suitable polymer, wherein said polymeric material is impermeable to light, preferably, entirely non-transparent. The body 10 may further comprise a filler, such as expanded polystyrene (EPS), for example. EPS filler density is about 25 kg/m.

In the body 10 of the device 100 a number of recesses 11 are periodically arranged to a predetermined depth. The recesses are arranged circumferentially, i.e. around the periphery of the body 10. In preferred embodiment said recesses 1 are equidistantly spaced and disposed at the same level. However, arrangement of the aforesaid recesses 11 at varying levels and/or with (periodically) variable spaces therebetween is not excluded. Length of said recesses 11 may vary within a range of 15-50 cm; width-within a range of 1-15 cm; and depth-within a range of 1-5 cm. Each device 100 may comprise 6-20 recesses, preferably 12 recesses.

As mentioned hereinabove, the device 100 comprises an at least one light source 13A, 13B (FIGS. 1A, 1B). The at least one light source 13A, 13B is preferably provided as a light emitting diode (LED) or as a laser diode (LD).

In one embodiment the device 100 comprises an at least one external light source 13A (FIG. 1A) provided at the top of the body (10). The at least one external light source 13A may be provided as a light-emitting diode or a laser diode with a visual range of 0.5-10 km (about 0.27-5.4 International nautical miles). It is preferred that visual range is adjustable. The external light source 13A may be configured as a lantern installation of any appropriate kind, specially designed for floating waterway marker devices, such as buoys or waterway-/marine navigation marks.

In another embodiment the device 100 comprises an at least one internal light source 13B (FIG. 1B) being at least partly incorporated into the body 10. A number of internal light sources 13B may be required to assure sufficient visual range (as discussed above). The light source(s) 13B are incorporated into the body 10 of the device 100 during manufacturing thereof

The aforementioned light emitting- and laser diodes may be provided in any desired color; however, for waterway navigation purposes provision of an at least green and/or red lights is preferred.

The device 100 further comprises a number of optical fibers 14 coupled to the at least one light source 13A, 13B and extending therefrom to each of the recesses 11. Each optical fiber 14 is advantageously configured to convey incoming light emitted by the light source 13A, 13B such, that outgoing light is directed to an ambient around the periphery of the floating waterway marker device 100, in particular, within an area defined by each recess 11. For those skilled in the art it is clear that direction(s) of outgoing light may be adjusted by varying a number and/or disposition of the recesses 11 and/or the optical fibers 14 on the device 100.The light source 13A, 13B may be coupled to an at least one optical fiber. In some embodiments the amount of optical fibers 14 provided within a single device 100 corresponds to the amount of recesses 11; in some other embodiments various bundling arrangements are utilized, wherein several optical fibers are extended towards an individual recess. In some exemplary embodiment the device 100 may comprise twelve recesses 11, one light source 13A or 13B and twelve optical fibers 14, wherein each optical fiber is coupled to the common light source.

In some embodiment the optical fibers 14 are conventional plastic optical fibers (polymer optical fibers; POF) that transmit light through their cores. Optical fibers 14 made of poly(methyl methacrylate) (PMMA) are preferably utilized; however, use of optical fibers made of other polymers, such as polystyrene, for example, is not excluded, provided that said polymer is suitable for the purposes of transmitting light from one end of the fiber to another. Optical fibers made of glass or silica may also be utilized.

In some other embodiments, each optical fiber 14 advantageously encompasses an encased fiber assembly, in where a number of optical fibers allocates within an individual sheath. Such encased solutions may be utilized for further bundling.

It is further preferred that a branching arrangement is employed, such as a distribution box 15 shown on FIG. 1A, to efficiently convey light from each light source to a number of optical fibers. In some embodiments also the internal light source(s) 13B may be included into the distribution box (not shown).

Each recess 11 is further configured to receive a light transmissive layer 12 thereinto, said layer being generally configured to transmit light therethrough. In some embodiments the light transmissive layer 12 is configured as a protective film, such as a weather-protective film, for example, thus implying no further optical functionality except transmittal of essentially all incoming light therethrough.

In some further embodiments the light transmissive layer 12 is imparted with an at least one optical functionality, as discussed herein below.

In the aforesaid embodiments, each optical fiber 14 is advantageously configured to convey light emitted by the light source 13A, 13B to or through the light transmissive layer 12.

The light transmissive layer 12 may be disposed within the recess 11 such as to attach to a base thereof Alternatively, the light transmissive layer 12 may be disposed such, that a clearance (a slot) is formed between the base of the recess 11 and the layer 12. In a latter case the light transmissive layer 12 may be disposed into the recess 11 in a sliding manner by means of sliding grooves or similar appliances provided at the sides of the recess 11, for example (not shown).

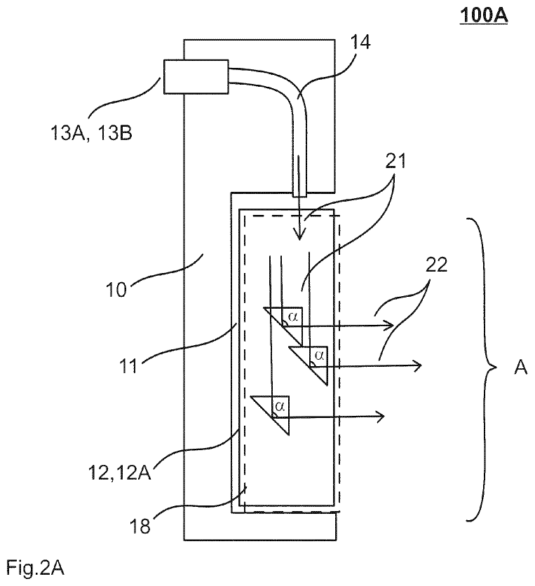

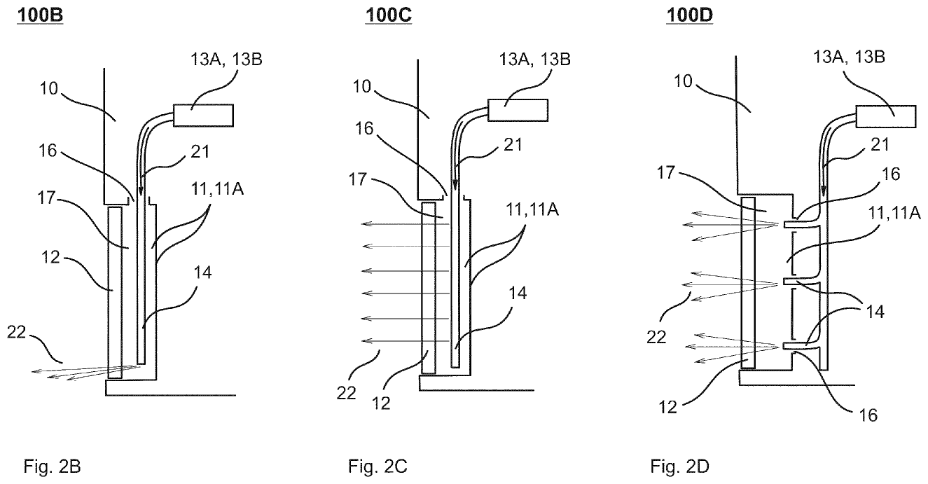

Reference is made to FIGS. 2A-2D illustrating in detail arrangement of elements in the body 10 of the device 100. Each of the FIGS. 2A-2D is a schematic representation of a longitudinal cross-section along a crosscut line D-D′ (shown, by the way of an example, on FIG. 1B) that cuts longitudinally across the recess 11 that receives the light transmissive layer 12. The expression “arrangement of elements” is used hereby to indicate disposition of the individual optical fibers 14 with regard to corresponding recesses 11 and the light transmissive layers 12 within the body 10 of the device 100.

General provision of the device 100 shown on FIGS. 2A-2D is such that in the light-impervious body 10 of said device at least one light source 13A, 13B is coupled to a number of optical fibers 14 and each optical fiber 14 extends from the light source to the individual recess 11 that, in turn, may further receive the light transmissive layer 12. Hereby, each optical fiber 14 is configured to convey light rays 21, emitted by the at least one light source 13A, 13B, to or through the light transmissive layer 12 such, that light rays 22 exiting the light transmissive layer 12 are directed to an ambient around the periphery of the floating waterway marker device 100. In particular with regard to the light transmissive layer 12, light rays 21 emitted by the light source constitute incoming light, whereas light rays 22 exiting said light transmissive layer 12 constitute outgoing light.

The light transmissive layer 12 may be provided in any desired color. However, whether a LED or an LD of a desired color can be utilized, coloration of the light transmissive layer 12 may be omitted.

FIG. 2A illustrates at 100A an embodiment, in which the light transmissive layer 12 comprises an optically functional surface 12A formed by an array of optically functional elements configured, in terms of shape, orientation and disposition thereof on the light transmissive layer 12, to redirect incoming light 21 rays to the ambient A at a preselected angle α (alpha) within a range of 45-120 degrees, preferably 90 degrees. The aforesaid optically functional elements may be provided in the form of prismatic reflectors, as shown on the FIG. 2A. Alternative configurations include cone-shaped reflectors, lens reflectors, or any other type of reflector appropriate for use hereby (not shown).

By the arrangement of elements within the device 100A (FIG. 2A), the incoming from a substantially downward direction light rays 21 can be efficiently redirected at a preselected angle. It is preferred that said incoming light rays 21 are redirected at an angle of about 90 degrees, thereby the outgoing light rays 22 exit the light transmissive layer 12 in a direction substantially perpendicular to that of the incoming rays 21. Provision of the device 100A thereby allows for both internal and external disposition of the optical fibers 14 with regard to the body 10, i.e. in principle the optical fibers 14 may be extended from the light source 13A, 13B to the recesses 11 also along an external surface of the body 10, as further discussed herein below.

FIG. 2A further illustrates an additional configuration, in which the above described optically functional surface 12A is provided on an additional optically functional layer 18 (shown in dashed line) disposed over or under the light transmissive layer 12. Whether the embodiment 100A employs the additional optically functional layer 18, then the optical functionality related to redirecting incoming light 21 at a preselected angle is incurred by provision of said additional layer 18 comprising the optically functional surface 12A. The optically functional layer 18 may be configured as a diffractive layer, such as a diffractive film, for example. The diffractive layer may comprise a plurality of optically functional elements, such as diffractive lenses, arranged in a predetermined pattern, for example. Collimator lenses that use total internal reflection (TIR) may be utilized.

Hence, FIG. 2A generally relates to the device 100 (embodied as 100A), in which the incoming light rays 21 arrive onto the optically functional surface 12A, wherein redirection of said light ray 21 occurs, at a preselected angle, by means of the optically functional elements provided on said optically functional surface 12A, thereafter the outgoing light ray 22 (whose direction has been changed by means of said optically functional elements) exits the surface 12A. The optically functional surface 12A may in turn be provided on the light transmissive layer 12 or on the additional layer 18. The light transmissive layer 12, in turn, may be further configured as a (retro)reflective layer.

FIGS. 2B, 2C and 2D illustrate at 100B, 100C and 100D, accordingly, various embodiments of the floating waterway marker device 100, comprising the light transmissive layer 12, wherein a clearance (a slot) 17 is formed between a base 11A of the recess 11 and the light transmissive layer 12 upon receiving said layer 12 into the recess 11.

It should be noted, that the devices 100B, 100C and 100D are fully functional also in an absence of the light transmissive layer 12.

The arrangement of elements provided on FIGS. 2B-2D may be described as follows. The recess 11, formed in the body 10, may be further described as a rectangular lidless receptacle, elongated in a longitudinal (vertical) direction and having a base 11A, a top flank, a bottom flank and two side flanks. The distance between the top flank and the bottom flank is used to determine the length of the recess; whereas the distance between two side flanks is used to determine the width thereof The distance measured as from the outer surface of the body 10 to the base 11A is used to determine the depth of the recess 11.

Upon receiving the light transmissive layer 12 into said recess 11 a clearance 17 is formed between the base 11A and the layer 12. The light transmissive layer 12 thus acts as a “lid” for the receptacle described above. Accordingly, the distance measured as from the light transmissive layer 12 to the base 11A of the recess 11 can be used to determine the depth of said clearance 17. In various embodiments depth of the clearance 17 may vary. Typically, the depth of the clearance 17 may vary within 1-20 mm.

The arrangement of elements shown on FIGS. 2B-2D allows for receiving the at least one optical fiber 14 into said clearance 17 via an at least one aperture 16 formed in the body 10. The aperture or apertures 16 can be further provided with a sleeve or a ferrule.

FIGS. 2B and 2C illustrate at 100B and 100C, accordingly, related embodiments, wherein the optical fiber 14 is received into the clearance 17 via the aperture 16 arranged at the top flank of the recess 11.

FIG. 2B illustrates at 100B an embodiment, comprising the optical fiber 14 made of a light-carrying core with a light-impermeable protective coating (cladding). Hence, when said optical fiber 14 is inserted into the clearance 17 via the top-flank aperture 16, the incoming light ray 21 is conveyed to the light transmissive layer 12 through a light-emitting end of said fiber. Thereby, the outgoing light ray 22 is allowed to penetrate the light transmissive layer 12 within a predetermined region.

FIG. 2C illustrates at 100C an embodiment similar to that of FIG. 2B. However, the device 100C exploits the optical fiber 14 configured to distribute light emitted by the light source 13A, 13B along an entire length thereof. The so-called side-emitting fibers made of a light-carrying core are advantageously utilized. Alternatively, optical fibers 14 with protective cladding at least partly stripped off may be utilized; thereupon a light emitting/light distributing surface is created along that portion of said optical fiber 14 inserted into the clearance 17. Hence, when said optical fiber 14 is inserted into the clearance 17 via the top-flank aperture 16, the incoming light ray 21 is conveyed to the light transmissive layer 12 along an entire length of that portion of the optical fiber 14 received into the clearance 17.

FIG. 2D illustrates at 100D a further embodiment, in which the least one optical fiber 14 is received into the clearance 17 via the at least one aperture 16 provided in the base 11A of the recess 11. The embodiment allows for receiving a bundle of optical fibers 14 into the clearance 17 in an efficient manner. Thus, FIG. 2D shows a bundle of three optical fibers 14 received into the clearance 17 via the corresponding apertures 16. Each optical fiber 14 within the bundle can be configured as an individual fiber or as an encased fiber assembly. When each of the optical fibers 14 is inserted into the clearance 17 via the corresponding aperture 16 provided in the base 11A of the recess 11, the incoming light ray 21 is conveyed to the light transmissive layer 12 at a number of predetermined regions located along an entire length of that portion of the optical fiber 14 inserted into the clearance 17. The device embodied as 100D may be configured to generate, within each recess 11 thereof, sequential light signals that would cause an effect of a light string moving “upwards” or “downwards”.

In some preferred embodiments, the device 100 comprises the light transmissive layer 12 configured as a reflective layer. Said reflective layer is preferably a retroreflective layer, wherein the prefix “retro” indicates hereby the property to reflect external light, arriving from a water-craft approaching to the floating waterway marker device 100, for example, back towards its source (i.e. towards said water-craft). In some embodiments, the reflective layer may be selected form the group consisting of: a reflective film, a reflective tape, a reflective panel, a reflective strip, and a reflective coating. Conventional (retro)reflective appliances listed above are utilized.

The reflective layer may be disposed within the recess 11 such as to attach to a base thereof (e.g. 100A, FIG. 2A; the reference numeral 12 corresponds to the reflective layer). Hereby, a reflective layer in the form of a reflective coating or an adhesive tape may be utilized.

The reflective layer may be further implemented as a luminescent coating. Implementation of the reflective layer as a luminescent coating is particularly suitable for use with laser diodes.

Alternatively, the reflective layer may be disposed such, that a clearance (a slot) is formed between the base of the recess 11 and said layer (100B, 100C, 100D, FIGS. 2B-2D, accordingly; the reference numeral 12 corresponds to the reflective layer).

It should be noted, that the devices embodied as 100B, 100C and 100D (FIGS. 2B-2D) can comprise the reflective layer in the form of conventional (retro)reflective appliances. Thereby, provision of the optically functional surface 12A for the aforesaid embodiments is optional.

In some embodiments the device 100 is further provided with an at least one power source (not shown).

In some alternative embodiments, the optical fibers 14 may be replaced by electrical conductor wires, provided with an at least one light source or a light source module, such as LED or a LED module, at the end thereof Such conductor wires are advantageously configured to connect the aforesaid at least one power source to the LEDs or LED modules. Thus, in the embodiment shown on FIG. 2D, for example, the conductor wires 14 (replacing, hereby, the optical fibers), may extend from a power source to the apertures 16, wherein a light source, such as LED or LED module, may be placed within each aperture 16, respectively.

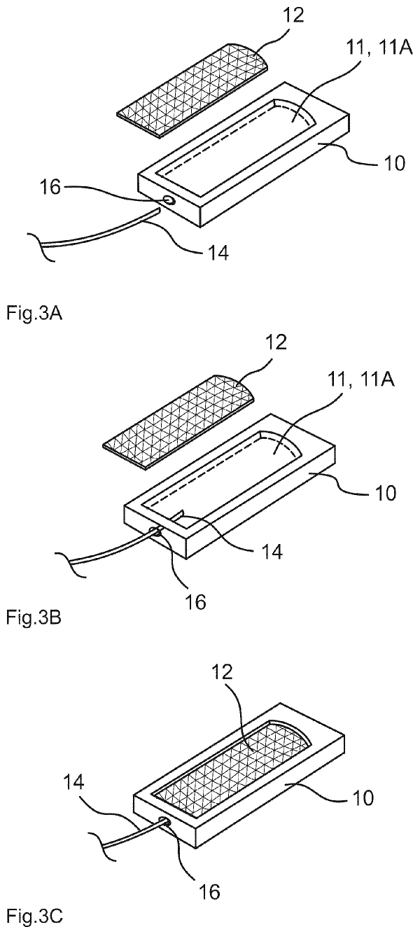

Reference is further made to FIGS. 3A-3C illustrative of a process for assembling the arrangement of elements in the body 10 of the floating waterway marker device 100 implemented according to some exemplary embodiments. Hereby, a process for assembling the arrangement of elements for the devices 100B and 100C (FIGS. 2B, 2C) is shown. According to the above described embodiments of FIGS. 2B and 2C, the optical fiber 14 is received into the clearance formed between the base 11A of the recess 11 and the light transmissive layer 12 via the (top-flank) aperture 16. Upon assembling, the optical fiber 14 may be inserted into the aperture 16 either prior to or after provision of the light transmissive layer 12 within the recess 11.

The arrangement of elements for the device embodied as 100D (FIG. 2D), employing a bundle of optical fibers 14, may be assembled in similar manner; wherein the optical fibers 14 may be received within the clearance formed between the base 11A and the light transmissive layer 12 via a number of apertures 16 provided in the base 11A.

Assembling the arrangement of elements for the device embodied as 100A (FIG. 2A) follows the processes described above with an exception that the optical fiber 14 is at least partly disposed over the light transmissive layer 12. Therefore, provision of the aperture 16 for the device 100A is optional. However, said device 100A further implies utilization of the optically functional surface 12A, provided either on the light transmissive layer 12 or on an additional optically functional layer 18, as discussed hereinabove.

The light transmissive layer 12 as shown on FIGS. 3A-3C may be configured as a reflective layer, as disclosed herein above. In such as case, once assembled arrangement of elements for the device 100 (illustrated, by the way of an example, by FIG. 3C) may be further supplied by an optional weather-protective layer disposed on the top of the reflective layer (not shown). Such weather-protective layer may be further provided in any desired color.

The device 100 embodied as any one of the 100A, 100B, 100C and 100D may be thus advantageously exploited as a light beacon. Light emissive function of said device 100 is preferably adjustable in terms of the parameters selected from the group consisting of: wavelength, frequency, cycle, amplitude, phase, time and intensity per time unit. The aforesaid parameters may be adjusted within each device 100.

The device 100 may further include additional appliances, such as indicative motifs (e.g. indicative of right- and left; cardinal directions, etc.), a variety of beacons (e.g. radio-, GPS, etc.), and the other indications.

In a further aspect of the invention an arrangement for marking a waterway navigation route is provided, said arrangement comprises a number of the floating waterway marker devices 100, embodied as any one of the 100A, 100B, 100C or 100D, wherein the floating waterway marker devices 100 within said arrangement are at least partly synchronized in terms of light emissive function thereof, said function selected from the group consisting of: wavelength, frequency, cycle, amplitude, phase, time and intensity per time unit.

An exemplary arrangement configured to deal with the above indicated daltonism problem illustrates functionality of the device(s) 100 therewithin. Said exemplary arrangement may be embodied as follows: (i) to include a number of navigation marks embodied as devices 100A, 100B, 100C and/or 100D configured to generate out of phase light signals; (ii) to include a number of lateral navigation marks, indicative of right and left, embodied as devices 100D and configured to generate, within a single device, sequential light signals that would cause an effect of a light string moving “upwards” or “downwards”; or (iii) to include a number of lateral navigation marks, wherein those marks indicative of e.g. right may be embodied as devices 100A, comprising the optically functional surface 12A, whereas the same indicative of e.g. left may be embodied as 100B-100D configured to generate point light signals.

It is clear to a person skilled in the art that with the advancement of technology the basic ideas of the present invention are intended to cover various modifications included in the spirit and the scope thereof The invention and its embodiments are thus not limited to the examples described above; instead they may generally vary within the scope of the appended claims.

1. A floating waterway marker device (100) comprising a body (10) and an least one light source (13A, 13B), wherein in the body (10) a number of periodically spaced recesses (11) are circumferentially arranged to a predetermined depth, wherein the waterway marker device (100) further comprises a number of optical fibers (14) coupled to said at least one light source (13A, 13B) and extending therefrom to each of the recesses (11), wherein each optical fiber (14) is configured to convey incoming light (21) emitted by the at least one light source (13A, 13B) such, that outgoing light (22) is directed to an ambient (A) around the periphery of the floating waterway marker device (100).

2. The floating waterway marker device (100) of claim 1, wherein each recess (11) is further configured to receive a light transmissive layer (12) thereinto, and wherein each optical fiber (14) is configured to convey incoming light (21) emitted by the at least one light source (13A, 13B) to or through said light transmissive layer (12).

3. The floating waterway marker device (100) of claim 2, wherein the light transmissive layer (12) comprises an optically functional surface (12A) formed by an array of optically functional elements configured, in terms of shape, orientation and disposition thereof on the surface (12A), to redirect incoming light (21) rays to the ambient (A) at a preselected angle α (alpha) within a range of 45-120 degrees.

4. The floating waterway marker device (100) of claim 3, wherein the optically functional surface (12A) is provided on an additional optically functional layer (18) disposed over or under the light transmissive layer (12).

5. The floating waterway marker device (100) of claim 2, wherein a clearance (17) is formed between a base (11A) of the recess (11) and the light transmissive layer (12) upon receiving the layer (12) into the recess (11).

6. The floating waterway marker device (100) of claim 5, wherein the at least one optical fiber (14) is received into the clearance (17) formed between the base (11A) of the recess (11) and the light transmissive layer (12) via an at least one aperture (16).

7. The floating waterway marker device (100) of claim 6, wherein said at least one aperture is (16) is provided in the base (11A) of the recess (11).

8. The floating water waterway marker device (100) of claim 2, wherein the light transmissive layer (12) is a reflective layer.

9. The floating waterway marker device (100) of claim 1, wherein the light source (13A, 13B) is a light emitting diode or a laser diode.

10. The floating waterway marker device (100) of claim 1, wherein the at least one light source is an external light source (13A) provided at the top of the body (10).

11. The floating waterway marker device (100) of claim 1, wherein the at least one light source is an internal light source (13B) at least partly incorporated into the body (10).

12. The floating waterway marker device (100) of claim 1, provided in the form of a buoy and/or a waterway navigation mark.

13. An arrangement for marking a waterway navigation route, wherein said arrangement comprises a number of the floating waterway marker devices (100) according to claim 1, wherein the floating waterway marker devices (100) within said arrangement are at least partly synchronized in terms of light emissive function thereof, said function selected from the group consisting of: wavelength, frequency, cycle, amplitude, phase, time and intensity per time unit.

14. The floating waterway marker device (100) of claim 2, wherein the light transmissive layer (12) comprises an optically functional surface (12A) formed by an array of optically functional elements configured, in terms of shape, orientation and disposition thereof on the surface (12A), to redirect incoming light (21) rays to the ambient (A) at a preselected angle α (alpha) of 90 degrees.

15. An arrangement for marking a waterway navigation route, wherein said arrangement comprises a number of the floating waterway marker devices (100) according to claim 2, wherein the floating waterway marker devices (100) within said arrangement are at least partly synchronized in terms of light emissive function thereof, said function selected from the group consisting of: wavelength, frequency, cycle, amplitude, phase, time and intensity per time unit.

16. An arrangement for marking a waterway navigation route, wherein said arrangement comprises a number of the floating waterway marker devices (100) according to claim 3, wherein the floating waterway marker devices (100) within said arrangement are at least partly synchronized in terms of light emissive function thereof, said function selected from the group consisting of: wavelength, frequency, cycle, amplitude, phase, time and intensity per time unit.

17. An arrangement for marking a waterway navigation route, wherein said arrangement comprises a number of the floating waterway marker devices (100) according to claim 4, wherein the floating waterway marker devices (100) within said arrangement are at least partly synchronized in terms of light emissive function thereof, said function selected from the group consisting of: wavelength, frequency, cycle, amplitude, phase, time and intensity per time unit.

18. An arrangement for marking a waterway navigation route, wherein said arrangement comprises a number of the floating waterway marker devices (100) according to claim 5, wherein the floating waterway marker devices (100) within said arrangement are at least partly synchronized in terms of light emissive function thereof, said function selected from the group consisting of: wavelength, frequency, cycle, amplitude, phase, time and intensity per time unit.

19. An arrangement for marking a waterway navigation route, wherein said arrangement comprises a number of the floating waterway marker devices (100) according to claim 6, wherein the floating waterway marker devices (100) within said arrangement are at least partly synchronized in terms of light emissive function thereof, said function selected from the group consisting of: wavelength, frequency, cycle, amplitude, phase, time and intensity per time unit.

20. An arrangement for marking a waterway navigation route, wherein said arrangement comprises a number of the floating waterway marker devices (100) according to claim 7, wherein the floating waterway marker devices (100) within said arrangement are at least partly synchronized in terms of light emissive function thereof, said function selected from the group consisting of: wavelength, frequency, cycle, amplitude, phase, time and intensity per time unit.
